(19) United States
(12) Patent Application Publication
(10) Pub. No.: US 2008/0318778 A1
(43) Pub. Date: Dec. 25, 2008

(54) Agriculture Composition Method Comprising Nitric Oxide Generating Agent

(75) Inventors: Alejandro Andres Riquelme Escobar, Santiago (CL); Manuel Pinto, Santiago (CL); Peter Horton, Sheffield (GB)

Correspondence Address: MERCHANT & GOULD PC, P.O. BOX 2903, MINNEAPOLIS, MN, 55402-0903, US

(73) Assignees: University of Sheffield, Sheffield (GB); UNIVERSIDAD DE CHILE, Santiago (CL)

(21) Appl. No.: 11/658,659

(22) PCT Filed: Jul. 20, 2005
(86) PCT No.: PCT/GB05/02855

§ 371 Date: Jan. 26, 2007

(30) Foreign Application Priority Data
Jul. 27, 2004 (GB) 0416629.4
Aug. 18, 2004 (GB) 0418418.0

(51) Int. Cl. A01N 59/00; A01N 43/08; A01P 21/00

(52) U.S. Cl. 504/124; 504/119; 504/140

(57) ABSTRACT

The invention discloses the use of a composition comprising at least one nitric oxide generating agent for increasing production of and/or retention of a plant organ.

The present invention relates to a method for changing the pattern of retention of flowers, fruits and pods comprising the step of applying a composition with at least one nitric oxide generating agent plus at least one hydrogen donating agent applied to the plant between the beginning of flowering and the end of the fruit and/or pod setting and also for changing the pattern of the dormancy breaking of the buds of plants when the composition is applied directly to the buds during the dormancy.

### Background to the invention

The shedding of leaves, flowers and fruit, referred to as abscission (organ separation), is a common regulatory phenomena in plants. The shedding of plant parts, both reproductive and vegetative, is important for reproduction, plant defence and continuation of perennial growth.

Abscission occurs by degradation of the primary cell wall and middle lamella surrounding cells in a separation layer that forms within a broad region of cell commonly referred to as the abscission zone. Although the control of abscission is not identical in all parts of the plant, a common pattern for the regulation of abscission is that ethylene induces and enhances the process, whereas auxin strongly inhibits it.

The dehiscent fruit of a plant from, for example, the family Leguminosae, (e.g beans or peas) is the seed pod. Whilst the number of pods per plant is determined by the number of fertilised flowers, which is set genetically, this is significantly affected by the number of flowers which abscise prematurely. A high rate of flower and pod abscission is a common phenomenon in crop plants, such as leguminous plants, (e.g common bean (Phaseolus vulgaris), soybean (Glycine max)).

Historically several approaches have been taken to overcome this diminished yield resulting from abscission. Such approaches include; breeding/selecting new varieties with improved yield, improved agronomic practice, application of fertilisers, introduction of new traits by insertion of transgenes and spraying with agrochemicals, such as pesticides and herbicides. WO02/061042 and WO03/088738 both disclose examples of the genetic manipulation of plants in order to reduce organ abscission. WO 02/061042 discloses a method for decreasing the rate of organ or floral abscission in which the ARF GAP domain of a gene, for example the NEVERSHED gene is modified. WO 03/088738 discloses tissue specific manipulation of the EIN2 and or EIN 3 ethylene signalling genes.

A reduced rate of abscission has been shown to be possible by causing a decrease in the levels of ethylene, a hormone particularly involved in controlling organ abscission. Both WO01/37663 and U.S. Pat. No. 5,100,462 disclose methods for applying chemicals to plants in order to inhibit the ethylene response. In WO 01/37663, cyclopropene derivatives and compositions are applied plants in an attempt to block ethylene receptors, whilst U.S. Pat. No. 5,100,462 discloses a method of applying an effective amount of diazocyclopentadiene (DACP), a competitor ethylene binding inhibitor, to plants.

Although a number of these approaches outlined above have been successful, they each have limitations. For example, there are environmental problems, such as ground water contamination, associated with the application of fertilisers, pesticides and herbicides and chemical compositions. Furthermore, while it is possible to genetically manipulate plants and identify new genotypes with increased pod numbers, one difficulty with such a strategy is that the new genotypes need to remain productive even under environmental stresses. Thus, whilst one genotype may have a good yield in a well watered environment, it may behave particularly poorly under drought conditions. There are also questions of cost and ease of use by the end user (e.g the farmer) to be considered for all of these approaches.

Nitric oxide (NO) is disclosed in U.S. Pat. No. 6,242,384B1 as being capable of enhancing the growth of vegetables, specifically leading to an increased crop performance. NO application, specifically in the form of sodium nitroprusside, was shown to enhance levels of chlorophyll, thus resulting in better photosynthetic capacity of the plant cells and also of the protective pigments such as anthocyanins and flavonoids. There is no suggestion in this document that the application of NO or NO generating system affects flower, fruits and/or pod abscission (retention). There is also no mention about effects on bud burst, flowering and fruit setting.

Nitric oxide has recently been identified as a molecule that operates within the signalling pathways associated with important plant regulators such as abscisic acid (AbA) and ethylene, key regulators of abscission and thus an increase in the level of NO within a plant was considered as a possible means of modulating abscission in plants. However, NO is gaseous and thus can not be used for foliar spraying.

In humans it has been found that a mixture of vitamin C (ascorbic acid, AsA) and sodium nitrite (NaNO₂) which together act as a NO generating system, can be applied to the skin as a gel which is used as a treatment for conditions in which there is an underlying NO deficiency. For example, a gel comprising KY Jelly™, NaNO₂ (5% weight/volume) and AsA (5% weight/volume) is used to treat the endothelial dysfunction caused by the decreased synthesis or accelerated inactivation of endothelium-derived relaxing factor in Raynaud's Syndrome (Tucker A T, et al The Lancet 1999; 354:1670-1675).

Surprisingly, we have found that the application of a composition comprising at least one nitric oxide generating agent, for example, NaNO₂ leads to an increase in pod number and/or yield in common bean and is thus a simple, cheap, effective, non-toxic and non-environmentally damaging solution to the problem of reduced crop yield due to low flower and fruit production and/or high abscission rates of them.

We have also found that the application of a composition comprising at least one nitric oxide generating agent, for example, NaNO₂ to dormant grapevine buds, significantly accelerates the breaking of the dormancy of the buds compared to non-sprayed buds. Consequently, this is a simple, cheap, effective, non-toxic and environmentally friendly method to substitute for, or decrease, the cold period normally required by deciduous fruit trees and grapevine to sprout and flower. Substitution or reduction of the cold requirements in these species allows an earlier and more homogeneous sprout in Mediterranean, desert or tropical areas.

### Statement of the Invention

Thus, according to an aspect of the invention, there is provided the use of a composition comprising at least one nitric oxide generating agent for reducing and/or inhibiting abscission of plant organs.

Inhibition of organ abscission can lead to an increase in pod yield, with the pods being the commercial end-product particularly in leguminous plants. As discussed above, inhibition of organ abscission can be achieved by decreasing ethylene levels and/or increasing NO levels.

Thus, in a preferred embodiment of the invention, the use of the composition when applied to the plant inhibits the organ abscission in a plant. Even more preferably the organ is selected from the group consisting of flowers, fruits and pods and the application is preferably done between the very beginning of flowering and the end of the fruit setting

In a further preferred embodiment of the invention, the use of the composition reduces the dormancy period of buds and accelerates the bud burst in a plant when applied during bud dormancy.

NO can not be directly applied as a foliar spray, however a composition comprising sodium nitrite (NaNO₂), acting as a NO generating agent, when applied to plants has been found to decrease the abscission (increase the retention) of flowers and fruits, whilst also being a non-toxic and cost effective solution.

Preferably the concentration of NaNO₂ is less than about 2 mM. More preferably, the concentration of NaNO₂ is less than about 500 μM. Even more preferably, the concentration of NaNO₂ is about 200 μM.

In alternative embodiments of the invention, other nitrite salts may be used, for example potassium nitrite (KNO₂)

In yet further embodiments of the invention, the nitrogen generating agent is urea (CH₄N₂O).

In an alternative embodiments of the invention, the NO generating agent is a nitrogen donating agent which produces compounds that indirectly lead to NO generation.

The effect of NaNO₂ on increased organ retention becomes statistically significant when a hydrogen donating agent is used to donate H+ ions to NaNO₂

Therefore, in a further preferred embodiment of the invention the composition comprises a hydrogen donating agent.

The chemical reaction between NaNO₂ and a hydrogen donating agent to generate NO is outlined below:

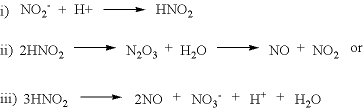

An example of a suitable hydrogen donating agent is ascorbic acid (AsA; C₆H₈O₆; vitamin C). The chemical reaction between NaNO₂ and AsA to generate NO is outlined below:

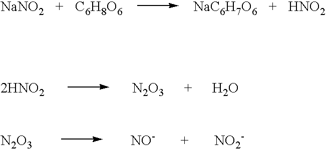

In a preferred embodiment of the invention the concentration of AsA is less than about 2 mM. More preferably, the concentration of AsA is less than about 500 μM. Even more preferably, the concentration of AsA is about 100 μM

In a still preferred embodiment of the invention the composition comprises a combination of NaNO₂ and AsA.

Alternative hydrogen donating agents to AsA will be known to those skilled in the art.

In a further preferred embodiment of the invention and when a reduction of flower and fruit abscission is needed, the composition is applied to the plant during flowering. More preferably, the application of the composition is applied to the plant between the beginning of flowering and the end of the fruit and/or pod setting. Even more preferably the application of the composition is continued until fruit and/or pod setting.

In a further preferred embodiment of the invention and when an earliest and more homogeneous breaking of the dormancy of buds is needed, the composition is applied to the plant during dormancy. More preferably, the composition is applied directly to the buds during the endodormancy of the buds.

In a further preferred embodiment of the invention the composition is applied to the plants as a spray. More preferably the composition is water soluble and thus the spray is water based.

The spray may be applied to leaves, shoots, fruits or any other aerial part of the plant or a combination of these parts. More preferably the composition is applied to flowers for control of abscission and directly to the buds for the control the breaking of dormancy in buds.

In alternative embodiments of the invention, the composition is applied to the plant systemically, for example via the root system. The composition may be in the form of, for example, water-soluble pellets/capsule which are applied to the growing medium (e.g soil or hydroponic cultures). Due to the reaction between NaNO₂ and AsA being spontaneous and resulting in the immediate generation of NO, NaNO₂ and AsA must be retained separately within a pellet/capsule and only brought together when the generation of NO is required. For example, AsA may itself be encapsulated within water-soluble capsules within the primary pellet/capsule.

Preferably, plants of the present invention are crop plants.

In a preferred embodiment of the invention the crop plant is a legume. Leguminous plants include beans and peas, guar, locust bean, fenugreek, soybean, garden beans, cowpea, mungbean, lima bean, fava been, lentils, chickpea. More preferably the legume is the common bean (Phaseolus vulgaris) and the soybean (Glycine max)

In a further preferred embodiment of the invention the crop plant is fruit bearing. Preferably the fruit is soft-skinned and is selected from the group consisting of; apple, pear, prickly pear, peach, plum, apricot, grape, cherry, orange blackberry, loganberry, raspberry, strawberry, gooseberry, lemon, orange, lime, grapefruit, olive, date, banana, cucurbits (e.g melon and water melon), pineapple, avocado, fig, chirimolla, guayava, mango, olive, papaya, tomato, pepper.

In a further preferred embodiment of the invention the fruit is hard-shelled (ie a nut). Preferably the nut is selected from the group consisting of; walnut, almond, pistachio, pine, pecan, walnut, brazil, cashew, macadamia, hazelnut, coconut, cocoa bean, coffee bean

In a further preferred embodiment of the invention, the crop plant is a vine, preferably a grape vine as Vitis vinifera L or other species from the gender vitis. The composition of the invention has been shown to accelerate the bud dormancy breaking in grape vines and thus provide early grapes on the vines.

In a further preferred embodiment of the invention the crop is a grain plant, for example; corn (Zea mays), wheat (Tritium asestivum), barley, rice (Orzya sativa), sorghum (Sorghum bicolor, Sorghum vulgare), rye (Secale cereale), oats etc.

In a further preferred embodiment of the invention the plant is an oil-seed plant for example; cotton (Gossypium hirsutum), soybean (Glycine max), safflower, sunflower (Helianthus annus), Brassica, maize, alfalfa, palm, coconut, etc.

Other horticultural crops to which the invention may be applied include, lettuce, spinach, endive, vegetable brassicas (e.g cabbage, broccoli, cauliflower), tobacco, carrot, potato, sweet potato, cassava, tea, sugar beets.

According to a further aspect of the invention there is provided a method of inhibiting organ abscission in a plant applying a composition comprising at least one nitric oxide generating agent to the plant.

In a preferred method of the invention the composition the nitric oxide generating agent is NaNO₂ or functional variants thereof.

More preferably, the composition further comprises a hydrogen donating agent. Even more preferably this hydrogen donating agent is AsA.

Preferably the concentration of NaNO₂ is less than about 2 mM and the concentration of AsA is less than about 2 mM. More preferably the concentration of NaNO₂ is about 200 μM and the concentration of AsA is about 100 μM.

In a further aspect of the invention there is provided a composition comprising a combination of AsA and NaNO₂. Preferably the concentration of NaNO₂ is less than about 2 mM and the concentration of AsA is less than about 2 mM. More preferably the concentration of NaNO₂ is about 200 μM and the concentration of AsA is about 100 μM.

According to a further aspect of the invention there is provided a composition comprising a combination of AsA and NaNO₂ wherein the composition is not a gel. In a preferred embodiment of the invention the concentration of NaNO₂ is less than about 2 mM and the concentration of AsA is less than about 2 mM. More preferably the concentration of NaNO₂ is about 200 μM and the concentration of AsA is about 100 μM.

In instances where a composition comprising NaNO₂ and AsA is to be applied to large scale areas of vegetation, for example, crops in fields, it may be preferable to apply the composition at the same time as other agents, for example, pesticides (e.g fungicides or insecticides) or fertilisers/floral nutrients.

An embodiment of the invention will now be described by example only and with reference to the following materials, methods and examples.

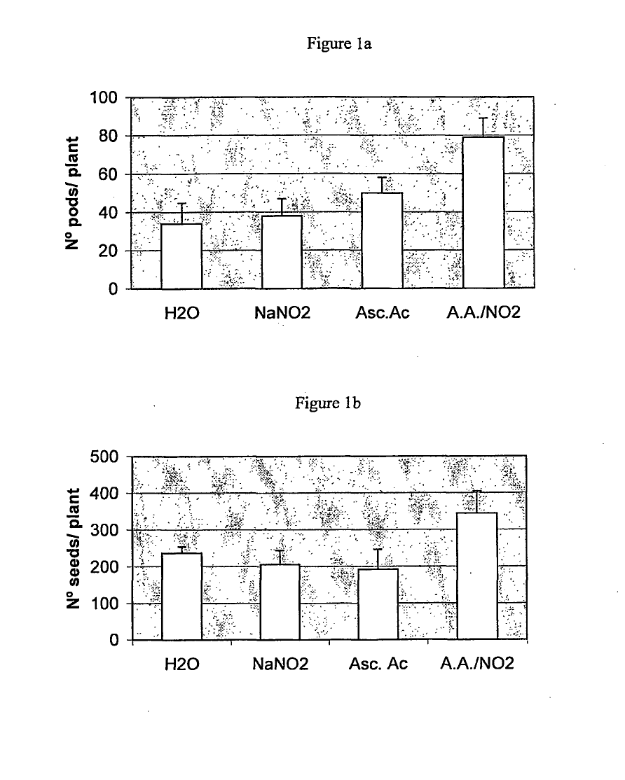

FIG. 1: Illustrates the effect of spraying NaNO₂, AsA and a mixture of AsA/NaNO₂ on the number of pods per plant of bean cv. Orfeo (Two Trials shown as FIGS. 1a and 1b respectively).

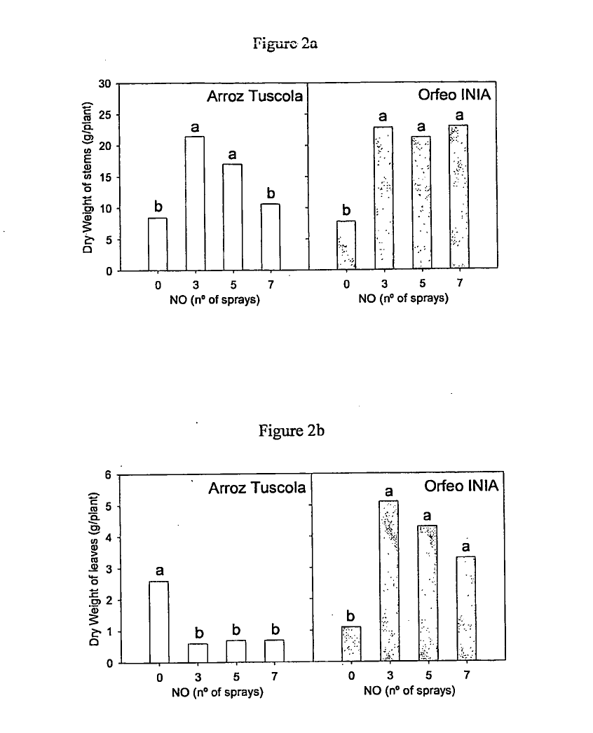

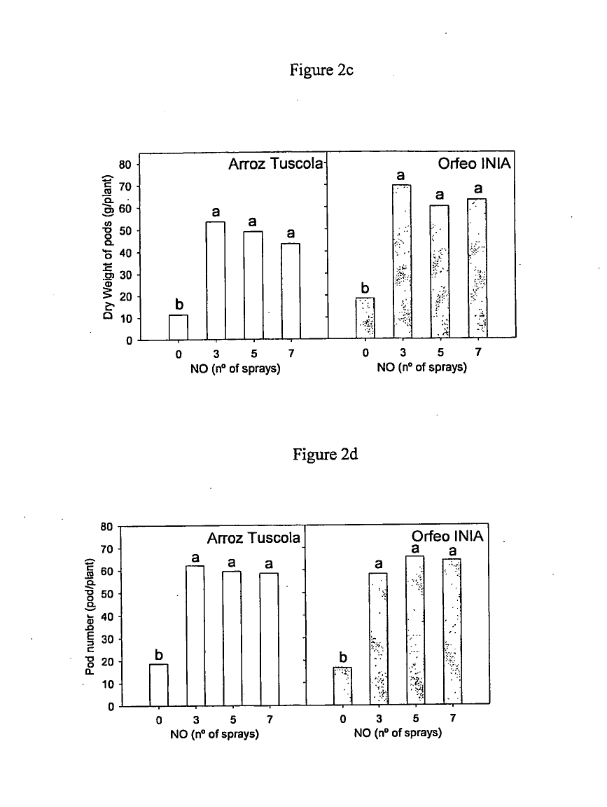

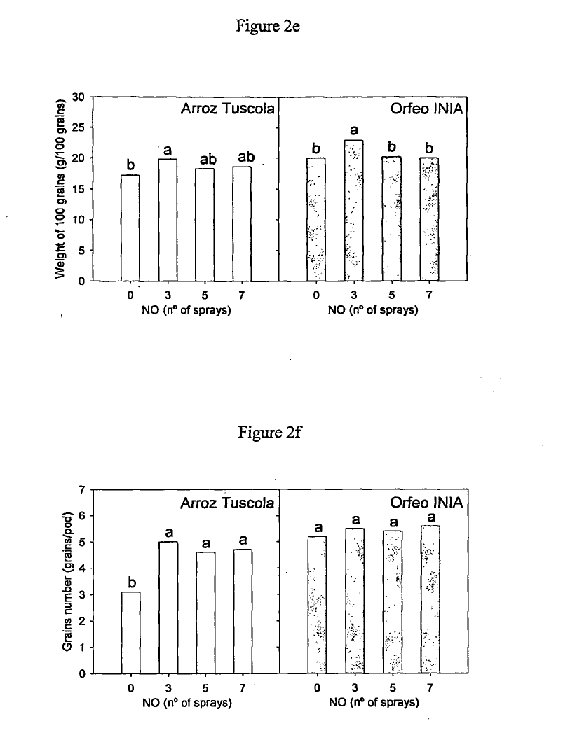

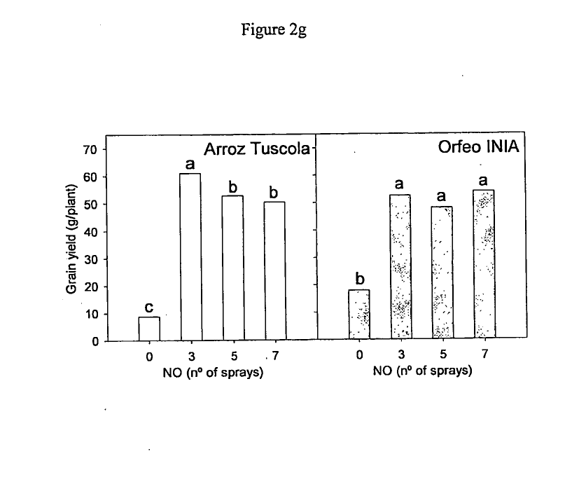

FIG. 2: Illustrates the effect of different number of sprays of a mixture of AsA/NaNO₂ on two bean varieties; cv Arroz Tuscola and Orfeo INIA on (A) biomass accumulation; dry weight of stems (FIG. 2a); dry weight of leaves (FIG. 2b) and dry weight of the pods (FIG. 2c); (B) Yield components; number of pods (FIG. 2d); number of grains per pod (FIG. 2e); weight of 100 grains (FIG. 2f) and (C) Grain production; weight of seed per plant i.e grain yield (FIG. 2g).

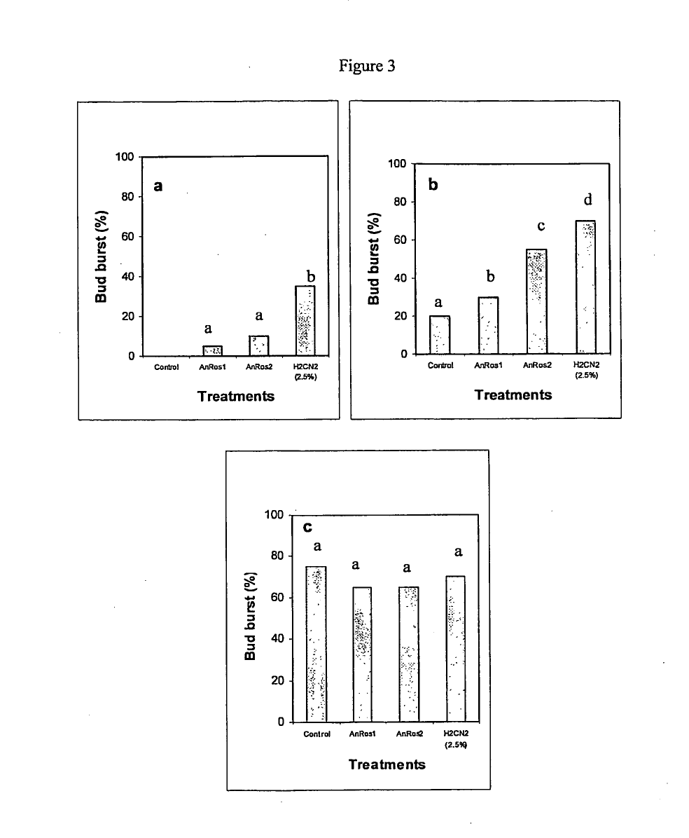

FIG. 3: Illustrates the effect of two different doses of spray of a mixture of AsA/NaNO2 applied to grapevine cv Sultana on the onset of budburst (as a percent of total buds)

FIG. 1: Illustrates that neither AsA or NaNO₂ alone had any effect on yield, but the mixture of AsA/NaNO₂ produce a significant increase in the yield (Number of pods/plant and Number of seed/plant) when applied as a spray to the bean cv. Orfeo INIA.

FIG. 2: Illustrates the dry weight of stems (FIG. 2a); dry weight of leaves (FIG. 2b); dry weight of pods (FIG. 2c); number of pods (FIG. 2d); the number of grains per pod (FIG. 2e); on the weight of 100 grains (FIG. 2f); and on the grain yield (FIG. 2g) of the bean cv. Arroz Tuscola and Orfeo INIA after spraying 4 weeks before flowering with a mixture of AsA (100 μM) and NaNO₂ (200 μM). Spraying was according to the following frequency: Control (T1) No spray; (T2) 3 sprays with AsA/NaNO₂ mixture; (T3) 5 sprays with AsA/NaNO₂ mixture; (T4) 7 sprays with AsA/NaNO₂ mixture. Sprays were performed every one week, starting ±30 days before flowering. Flowering time was considered when approximately 50% of the flowers were opened. Harvesting time when the pod was yellow and dry (14% humidity).

FIG. 3: Illustrates the effect of two different doses of spray of a mixture of AsA/NaNO2 applied to grapevine cv Sultana on the onset of bud burst (as a percent of total buds) at 22 days (a), 27 days (b) and 32 days (c) after spraying. AnRos₁=AsA(100 μM)+NaNO₂ 200 μM; AnRos₂=AsA (100 μM)+NaNO₂ 500 μM). Control did not receive any treatment. Also shown is the effect of cyanamide (H₂CN₂). Asa/NaNO₂ brings forward the onset of bud burst in grapevine by several days. After 22 days there was no bud burst in the control but 10% in the sprayed, and after 27 days, there was 60% bud burst in the sprayed compared to only 20% in the controls. The effect was not as strong as with cyanamide, a current commercial treatment, but this reagent is toxic and needs stringent precautions for use.

### MATERIALS AND METHODS

### Example 1

Plants of bean cv Orfeo INIA were grown in rows 80 cm apart and at a density of 10 plants/m, during the 2001 Southern Spring in the Experimental Station of the Univ. of Chile, Santiago. Plants were irrigated twice a week with abundant water in order to avoid water stress at any developmental stage. Phytosanitary, weed and fertilizer conditions of the plant was controlled as recommended for commercial crop.

One month old plants were sprayed every week for a two month period, until pod setting with: NaNO₂ at 200 μM; AsA at 100 μM and a mixture of AsA/NaNO₂ at 100M/200 μM. Control plants were sprayed with water. Results are shown in FIGS. 1a and 1b.

### Example 2

Plants of bean cv Arroz Tuscola and Orfeo INIA were grown in rows 80 cm apart during the 2002 Southern Spring in the Experimental Station of the Univ. of Chile, Santiago. Plants were irrigated twice a week with abundant water in order to avoid water stress at any developmental stage. Phytosanitary, weed and fertilizer conditions of the plant was controlled as recommended for a commercial crop.

4 weeks before flowering a mixture of AsA 100 μM and NaNO₂ 200 μM was sprayed according with the following frequency:
Control (T1) No spray
T2 3 sprays with AsA/NaNO₂ mixture
T3 5 sprays
T4 7 sprays

Sprays were performed every week, starting ±30 days before flowering. Flowering time was considered when approximately 50% of the flowers were opened. Harvesting time when the pod was yellow and dry (14% humidity).

Statistical design was: 4 treatments, distributed in two field blocks and 4 times replicated. Each replication was 6 plants harvested for analysis. So, in total 24 plants were harvested for each treatment. Data were analyzed by ANOVA and when differences were detected a Duncan test was performed in order to detect differences between specific treatments. Results are shown in FIG. 2(a-g).

### Example 3

Cuttings of grapevine cv Sultana with three dormant buds each were collected from a vineyard located at Antumapu Experimental Station, University of Chile, by the end of May 2003 (Autumn South Hemisphere). After fungicide treatment, they were kept wrapped up with plastic for one week in a dark and cold chamber at 7° C. day/night. After this period they were sprayed with the next solutions:
a) AsA(100 μM)+NaNO₂ 200 μM (in Figures, AnRos1)
b) AsA (100 μM)+NaNO₂ 500 μM). (in Figures AnRos 2)
c) H₂CN₂ 2.5%

Cuttings of Control did not receive anything.

After spray 12 cuttings per treatments were put in a growth chamber under hydroponic conditions and forced to burst keeping the temperature at 25°±1° C. day and night and the light intensity at 100 μmol quanta m⁻²s⁻¹ during 12H of photoperiod.

The number of buds burst was registered every day after the first bud was detected starting to growth. This moment was considered as the initiation of the bud burst.

1-47. (canceled)

48. A method for changing the pattern of the retention and/or the abscission of flowers, fruits and pods comprising the step of applying a composition with at least one nitric oxide generating agent plus at least one hydrogen donating agent applied to the plant between the beginning of flowering and the end of the fruit and/or pod setting and also for changing the pattern of the dormancy breaking of the buds of plants when the composition is applied directly to the buds during the dormancy.

49. A method according to claim 48, wherein the composition increase retention or inhibits organ abscission .in plants

50. A method according to claim 48, wherein the composition induces an earliest and homogeneous dormancy breaking of buds in plants.

51. A method according to claim 48, wherein the nitric oxide generating agent is sodium nitrite (NaNO₂) or a functional variant thereof.

52. A method according to claim 51, wherein the concentration of NaNO₂ is less than about 1 mM.

53. A method according to claim 52, wherein the concentration of NaNO₂ is less than about 500 μM.

54. A method according to claim 53, wherein the concentration of NaNO₂ is about 200 μM

55. A method according to claim 48, wherein the hydrogen donating agent is ascorbic acid (AsA;C₆H₈O₆; vitamin C) or a functional variant thereof.

56. A method according to claim 55, wherein the concentration of AsA is less than about 1 mM.

57. A method according to claim 56, wherein the concentration of AsA is less than about 500 μM.

58. A method according to claim 57, wherein the concentration of AsA is about 100 μM.

59. A method according to claim 55, wherein the composition comprises a combination of NaNO₂ and AsA or functional variants thereof.

60. A method according to claim 59, wherein the concentration of NaNO₂ is about 200 μM and the concentration of AsA is about 100 μM.

61. A method according to claim 48, wherein the composition is applied to the plant, more specifically to the reproductive organs between the flower button stage and the end of the fruit and/or pod setting.

62. A method according to claim 61, wherein the composition is continued to be applied to the plant until the fruit and/or pod setting.

63. A method according to claim 48, wherein the composition is directly applied to the buds at the time of bud dormancy, more precisely at the endo-dorrmancy period.

64. A method according to claim 48, wherein the plant is a crop plant.

65. A method according to claim 64, wherein the crop plant is a legume, a leguminous trees or a cereal.

66. A method according to claim 65, wherein the legume is the common bean (Phaseolus vulgaris) soybean (Glycine max), broad bean (Vicia fava) or any legume producing edible pods and/or seeds.

67. A method according to claim 63, wherein the crop plant is fruit bearing.

68. A method according to claim 65, wherein the cereal is corn (Zea mays).

69. A method according to claim 67, wherein the plant is a vines and/or a deciduous fruit trees.

70. A method according to claim 69, wherein the vine is a grape vine (Vitis vinifera L.).

71. A method according to claim 48, wherein the plant is used as an ornamental plant.
